(19) United States
(12) Patent Application Publication
(10) Pub. No.: US 2021/0408752 A1
(43) Pub. Date: Dec. 30, 2021

(54) METHOD FOR ASSEMBLING TERMINAL OF ELECTRICAL CONNECTOR

(71) Applicant: Dongguan Luxshare Technologies Co., Ltd, Dongguan City (CN)

(72) Inventor: Yung-Chih HUNG, Taipei City (TW)

(73) Assignee: Dongguan Luxshare Technologies Co., Ltd, Dongguan City (CN)

(21) Appl. No.: 17/238,304

(22) Filed: Apr. 23, 2021

(30) Foreign Application Priority Data
Jun. 24, 2020 (CN) 202010589630.2

(51) Int. Cl. H01R 43/20; H01R 43/16

(52) U.S. Cl. CPC H01R 43/20; H01R 43/16

(57) ABSTRACT

A method for assembling a terminal of an electrical connector. The electrical connector comprises a connector body, a plurality of lower terminal slots and a plurality of upper terminal slots corresponding to the plurality of lower terminal slots. The method comprising: providing a lower terminal component and an upper terminal component, wherein the lower terminal component comprises a plurality of lower terminals and a strip connecting with the plurality of lower terminals, and the upper terminal component comprises a plurality of upper terminals and a strip connecting with the plurality of upper terminals; disposing the lower terminal component in the plurality of lower terminal slots, wherein the plurality of lower terminals are respectively disposed in the corresponding lower terminal slots; and disposing the upper terminal component in the plurality of upper terminal slots, wherein the plurality of upper terminals are respectively disposed in the corresponding upper terminal slots.

### CROSS REFERENCE TO RELATED APPLICATION

This application claims the priority benefit of Chinese Patent Application Serial Number CN 202010589630.2, filed on Jun. 24, 2020, the full disclosure of which is incorporated herein by reference.

### BACKGROUND

### Technical Field

The present disclosure relates to the technical field of connectors, particularly to a method for assembling a terminal of an electrical connector.

### Related Art

Conventional electrical connectors comprise a connector body, a plurality of power terminals, and a plurality of signal terminals. The plurality of power terminals and the plurality of signal terminals are inserted in a plurality of terminal slots of the connector body. Each of the plurality of power terminals and each of the plurality of signal terminals are respectively inserted in the corresponding terminal slots. During the insertion process, first to insert the terminal and bend the terminal with the structure of the slot to form a vertical terminal. Secondly, in order to avoid the rebound of the terminal formed by the bending process mentioned above, after all the terminals are assembled, a positioning bottom cover should be installed at the terminal assembly end (one end away from the insertion end). However, it is reducing the overall terminal assembling efficiency by doing so.

### SUMMARY

The embodiments of the present disclosure provide a method for assembling a terminal of an electrical connector to solve the problem of the low overall terminal assembling efficiency resulting from the respective insertion of each of the plurality of power terminals and each of the plurality of signal terminals in the corresponding terminal slots, and the method how the terminals are formed of conventional connectors.

The present disclosure provides a method for assembling a terminal of an electrical connector. The electrical connector comprises a connector body, a plurality of lower terminal slots, and a plurality of upper terminal slots corresponding to the plurality of lower terminal slots. The method comprising: providing a lower terminal component and an upper terminal component, wherein the lower terminal component comprises a plurality of lower terminals and a strip connecting with the plurality of lower terminals, and the upper terminal component comprises a plurality of upper terminals and a strip connecting with the plurality of upper terminals; disposing the lower terminal component in the plurality of lower terminal slots, wherein the plurality of lower terminals are respectively disposed in the corresponding lower terminal slots; and disposing the upper terminal component in the plurality of upper terminal slots, wherein the plurality of upper terminals are respectively disposed in the corresponding upper terminal slots.

In the embodiments of the present disclosure, when the terminal component is disposed in the plurality of terminal slots, the plurality of terminals of the terminal component could be disposed in the plurality of terminal slots all at once by integrating a plurality of terminals into an integrated terminal component by a strip.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a rear view of a connector body of the first embodiment of the present disclosure;

FIG. 2 is an assembling flowchart of a terminal of the first embodiment of the present disclosure;

FIG. 3 is a schematic diagram of a bent lower terminal component of the first embodiment of the present disclosure;

FIG. 4 is a schematic diagram of a bent upper terminal component of the first embodiment of the present disclosure;

FIG. 5 is a schematic diagram of step S12 of the first embodiment of the present disclosure;

FIG. 6 is a schematic diagram of step S13 of the first embodiment of the present disclosure;

FIG. 7 is a schematic diagram of step S14 of the first embodiment of the present disclosure;

FIG. 8 is a schematic diagram of step S15 of the first embodiment of the present disclosure;

FIG. 9 is a perspective view of an electrical connector of the first embodiment of the present disclosure;

FIG. 10 is a schematic diagram of step S12 of the second embodiment of the present disclosure;

FIG. 11 is a schematic diagram of step S14 of the second embodiment of the present disclosure;

FIG. 12 is a rear view of a connector body of the third embodiment of the present disclosure;

FIG. 13 is an assembling flowchart of a terminal of the third embodiment of the present disclosure;

FIG. 14 is a schematic diagram of step S22 of the third embodiment of the present disclosure;

FIG. 15 is a schematic diagram of step S24 of the third embodiment of the present disclosure; and

FIG. 16 is a perspective view of an electrical connector of the third embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to member a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the disclosure.

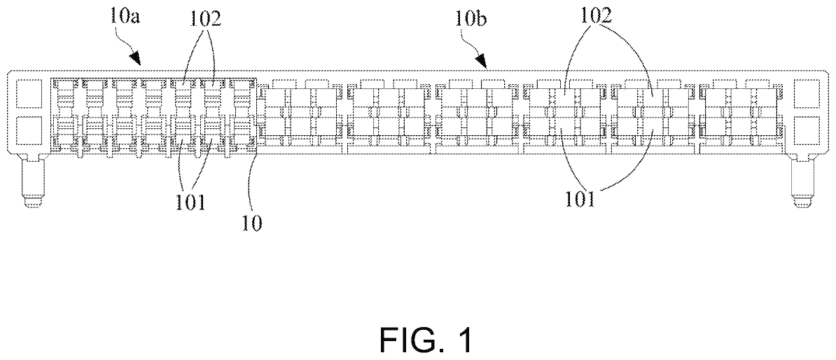

FIG. 1 is a rear view of a connector body of the first embodiment of the present disclosure. As shown in the figure, the electrical connector of this embodiment comprises a connector body 10 comprising a plurality of lower terminal slots 101 and a plurality of upper terminal slots 102. The plurality of lower terminal slots 101 are disposed in a row at intervals, and the plurality of upper terminal slots 102 are disposed in a row at intervals. The plurality of lower terminal slots 101 is disposed below the plurality of upper terminal slots 102, and respectively correspond to the plurality of upper terminal slots 102. A plurality of terminals could be rapidly disposed in the plurality of lower terminal slots 101 and the plurality of upper terminal slots 102 through method for assembling the terminal of the electrical connector of this embodiment.

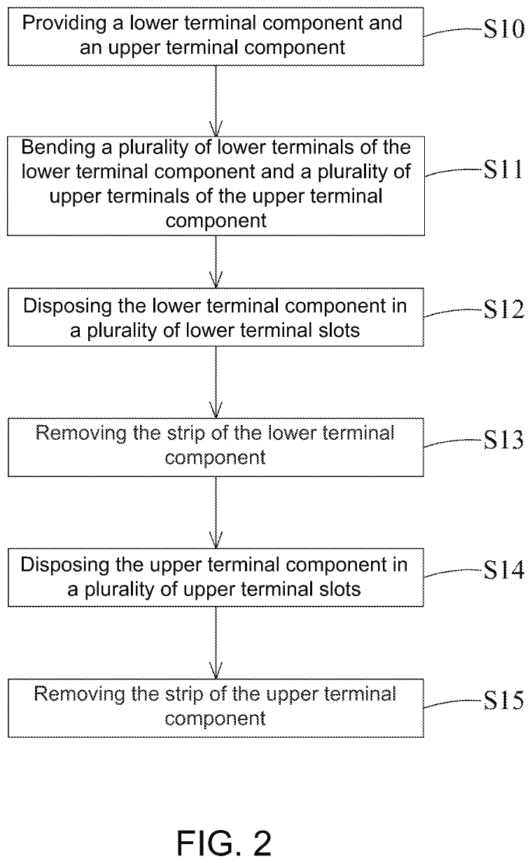

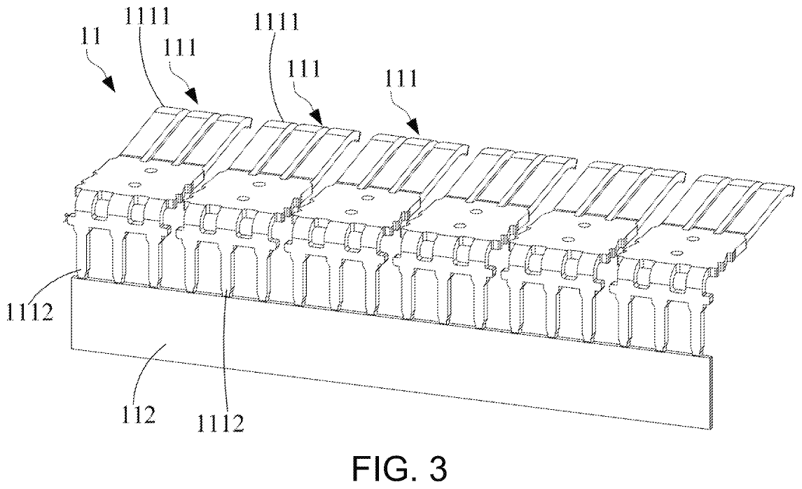

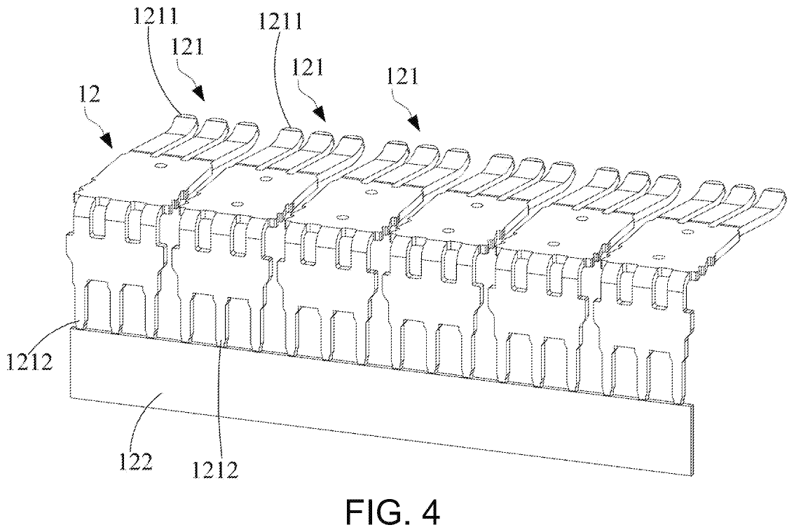

In FIG. 1, the connector body 10 comprises a signal area 10a and a power area 10b. Since the assembling method of the signal area 10a is identical to that of the power area 10b, in the following the power supply area 10b would be taken as an example for description. FIG. 2 is an assembling flowchart of a terminal of the first embodiment of the present disclosure. FIG. 3 is a schematic diagram of a bent lower terminal component of the first embodiment of the present disclosure. FIG. 4 is a schematic diagram of a bent upper terminal component of the first embodiment of the present disclosure. As shown in the figure, the terminal assembling method of this embodiment first performs step S10 to provide a lower terminal component 11 and an upper terminal component 12. The lower terminal component 11 comprises a plurality of lower terminals 111 and a strip 112. Each of the terminals 111 comprises a plugging end 1111 and a connecting end 1112. The plurality of connecting ends 1112 of the plurality of lower terminals 111 are connected by a strip 112, so that the plurality of lower terminals 111 are integrated. The upper terminal component 12 comprises a plurality of upper terminals 121 and a strip 122. Each of the upper terminals 121 comprises a plugging end 1211 and a connecting end 1212. The plurality of connecting ends 1212 of the plurality of upper terminals 121 are connected by a strip 122, so that the plurality of upper terminals 121 are integrated. In this embodiment, the lower terminal 111 and the upper terminal 121 are respectively power terminals.

In this embodiment, the lower terminal 111 and the upper terminal 121 are bent-shaped. Perform step S11 after S10 to bend the plurality of lower terminals 111 of the lower terminal component 11 and the plurality of upper terminals 121 of the upper terminal component 12, so that the plurality of lower terminals 111 of the lower terminal component 11 and the plurality of upper terminals 121 of the upper terminal component 12 are bent-shaped, respectively. In this embodiment, the bending of the lower terminal component 11 is to first secure one end of the lower terminal component 11 having the strip 112 onto a bending fixture, which allows the bending positions of the plurality of lower terminals 111 of the lower terminal component 11 to be aligned with the edges of the bending fixture. Then, fold one end of the lower terminal component 11 away from the strip 112 with respect to the bending fixture, so that the plurality of lower terminals 111 of the lower terminal component 11 could be formed in a bent shape. The bending process of the upper terminal component 12 identical to that of the lower terminal component 11, which would not be repeated herein again. In this embodiment, the plurality of lower terminals 111 of the lower terminal component 11 and the plurality of upper terminals 121 of the upper terminal component 12 are bent simultaneously, which enables the bending angles of the plurality of lower terminals 111 of the lower terminal component 11 to be consistent, and enables the bending angles of the plurality of upper terminals 121 of the upper terminal component 12 to be consistent. Thus, the plurality of connecting ends 1112 of the plurality of lower terminals 111 disposed in the plurality of lower terminal slots 101 could stay on the same line, and the plurality of connecting ends 1212 of the plurality of upper terminals 121 disposed in the plurality of upper terminal slots 102 could stay on the same line. When the plurality of lower terminals 111 and the plurality of upper terminals 121 are arranged straightly, step S11 could be omitted and the next step can be directly performed.

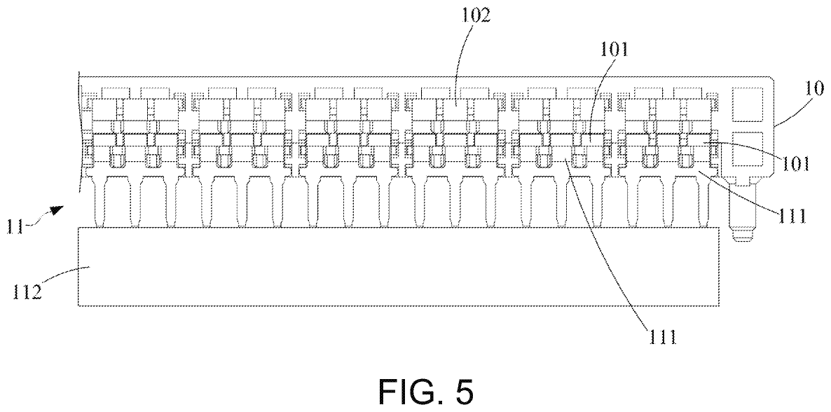

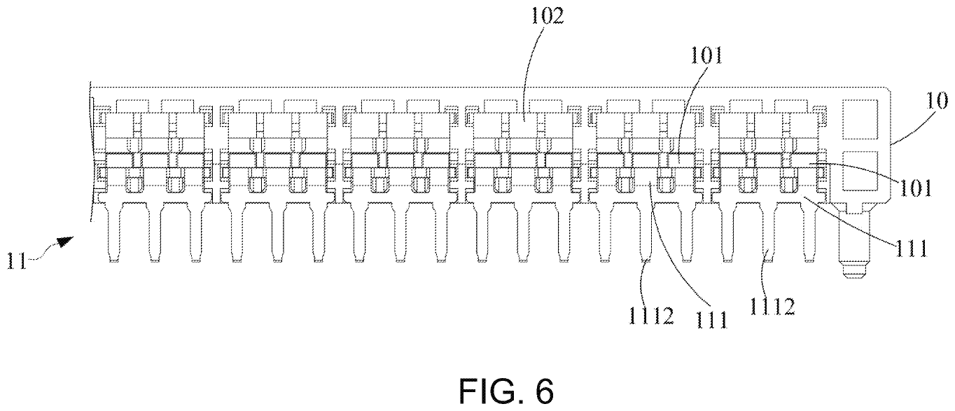

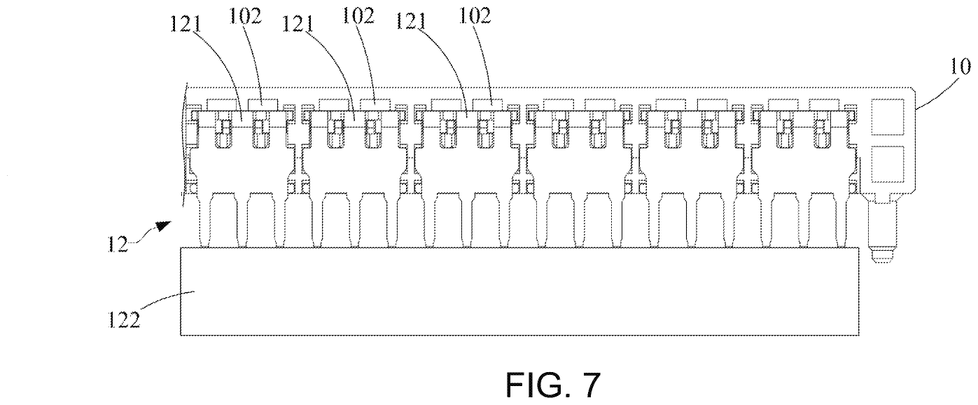

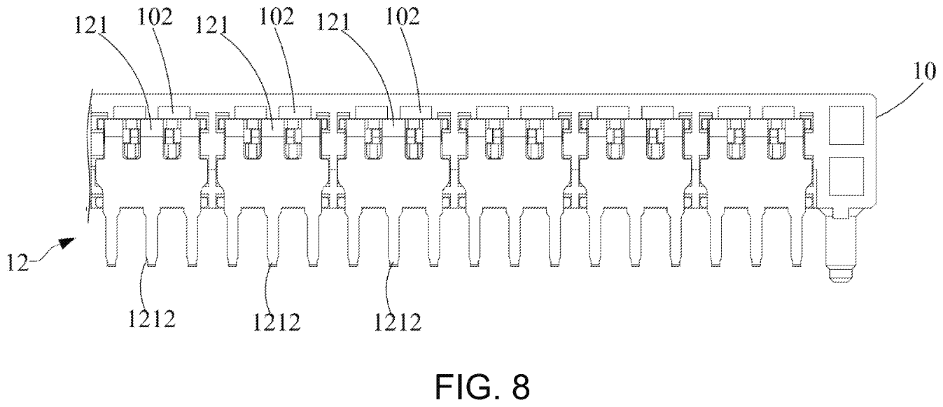

FIG. 5 to FIG. 8 are schematic diagrams of steps S12 to S15 of the first embodiment of the present disclosure. As shown in the figure, step S12 is then proceeded, in which the lower terminal component 11 is disposed in the plurality of lower terminal slots 101. That is, the plurality of lower terminals 111 of the lower terminal component 11 are respectively inserted into the corresponding lower terminal slots 101, and the strip 112 is disposed at the outside of the connector body 10. In step S13, the strip 112 of the lower terminal component 11 is removed. In step S14, the upper terminal component 12 is disposed in the plurality of upper terminal slots 102. That is, the plurality of upper terminals 121 of the upper terminal component 12 are respectively inserted into the corresponding upper terminal slots 102, and the strip 112 is disposed at the outside of the connector body 10. In step S15, the strip 122 of the upper terminal component 12 is removed. After performing the steps above, the terminal assembling of the power area 10b is completed. The terminal assembling of the signal area 10a can also be performed according to the above steps, with merely replacing the plurality of lower terminals 111 of the lower terminal component 11 and the plurality of upper terminals 121 of the upper terminal component 12 with signal terminals. Since the lower terminal component 11 and the upper terminal component 12 are bent (step S11) before disposed in the plurality of lower terminal slots 101 and the plurality of upper terminal slots 102, no additional positioning bottom cover is required to prevent the terminal from rebounding, which could reduce the overall size and weight of the electrical connector, and also reduce the assembling difficulty.

In this embodiment, the terminal assembling method is basically to first assemble the plurality of lower terminals 111 in the plurality of lower terminal slots 101 in the lower row. Then, the plurality of upper terminals 121 are assembled into the plurality of upper terminal slots 102 in the upper row. In addition, through the terminal assembling method of this embodiment, the plurality of lower terminals 111 to be assembled in the plurality of lower terminal slots 101 are connected by the strip 112 to form an integration of lower terminal component 11, and the plurality of upper terminals 121 to be assembled in the plurality of upper terminal slots 102 are connected by a strip 122 to form an integration of upper terminal component 12. Through this method, the plurality of lower terminals 111 can be assembled in the plurality of lower terminal slots 101 at a time, and the plurality of upper terminals 121 can be assembled in the plurality of upper terminal slots 102 at a time. For example, when the number of lower terminal slots 101 is six, the number of lower terminals 111 of the lower terminal component 11 is also six. When the lower terminal component 11 is disposed in the plurality of lower terminal slots 101, the six lower terminals 111 of the lower terminal component 11 are disposed in the six lower terminal slots 101, thereby improving the overall terminal efficiency of assembling. The plurality of connecting ends 1112 of the plurality of lower terminals 111 can be disposed on the same line, and the plurality of connecting ends 1212 of the plurality of upper terminals 121 can be disposed on the same line to facilitate the connection with the circuit board.

In this embodiment, the number of lower terminal assemblies 11 is one. The number of lower terminals 111 of the lower terminal component 11 is more than two. So, the number of lower terminals 111 of the lower terminal component 11 is identical to the number of lower terminal slots 101. The number of upper terminal assemblies 12 is one. The number of upper terminals 121 of the upper terminal component 12 is more than two. So, the number of upper terminals 121 of the upper terminal component 12 is identical to the number of upper terminal slots 102.

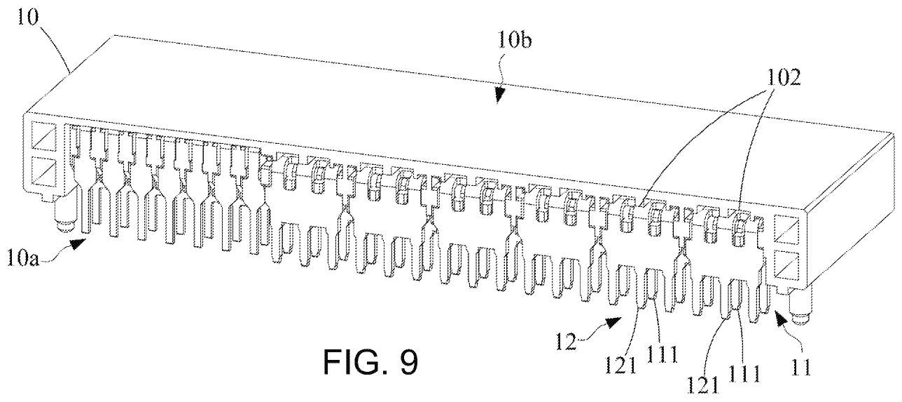

FIG. 9 is a perspective view of an electrical connector of the first embodiment of the present disclosure. As shown in the figure, in this embodiment, the length of the plurality of lower terminals 111 of the lower terminal component 11 protruding from the connector body 10 is different from the length of the plurality of upper terminals 121 of the upper terminal component 12 extending from the connector body 10. So, a gap would exist between the plurality of lower terminals 111 of the lower terminal component 11 exposed on the connector body 10 and the plurality of upper terminals 121 of the upper terminal component 12 exposed on the connector body 10, which prevents the plurality of connecting ends 1212 of the plurality of upper terminals 121 disposed in the upper terminal slot 102 from contacting with the plurality of connecting ends 1112 of the plurality of lower terminals 111 disposed in the lower terminal slot 101.

In one embodiment, step S13 can be executed after step S14, that is, executed with step S15, which indicates that the strip 112 of the lower terminal component 11 and the strip 122 of the upper terminal component 12 are removed when the lower terminal component 11 is disposed in the plurality of lower terminal slots 101 and the upper terminal component 12 is disposed in the plurality of upper terminal slots 102.

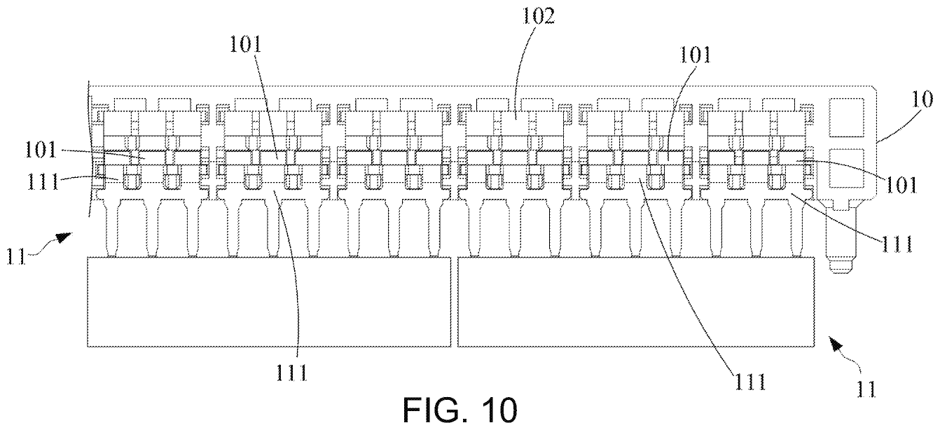

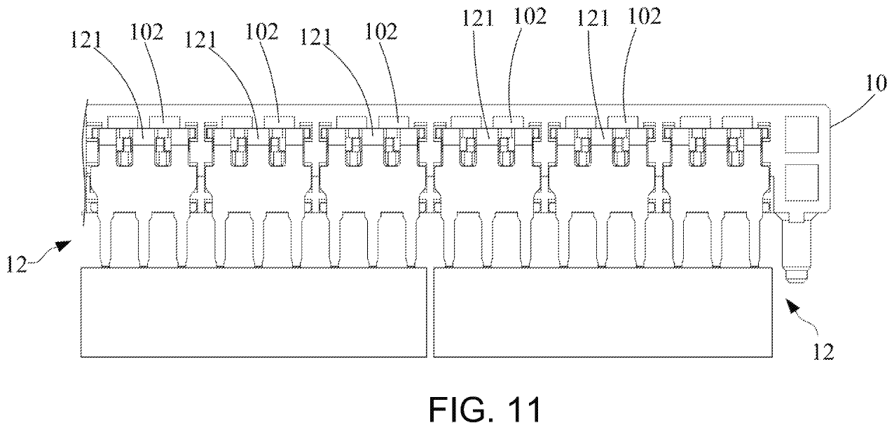

FIG. 10 and FIG. 11 are schematic diagrams of step S12 and S14 of the second embodiment of the present disclosure. As shown in the figure, the terminal assembling method of this embodiment is different from that of the first embodiment in that the number of lower terminal assemblies 11 can be plural, and the number of upper terminal assemblies 12 can also be plural. For example, when the number of lower terminal slots 101 is six, the number of upper terminal slots 102 is also six; when the number of lower terminal assemblies 11 is two, the number of upper terminal assemblies 12 is also two; when the number of lower terminals 111 of each of the lower terminal assemblies 11 is three, the number of upper terminals 121 of each of the upper terminal assemblies 12 is three. In this embodiment, the two lower terminal assemblies 11 are installed in the six lower terminal slots 101 as the step S12, and the two upper terminal assemblies 12 are installed in the six upper terminal slots 102 as the step S14. In this embodiment, the terminal assembling method is to first complete the terminal assembling of the plurality of lower terminal slots 101, then to complete the terminal assembling of the plurality of upper terminal slots 102.

The number of the foregoing lower terminal assemblies 11 is plural. The total number of the lower terminals 111 of the plurality of lower terminal assemblies 11 is equal to the number of the lower terminal slots 101. The number of the lower terminals 111 of each of the lower terminal assemblies 11 is more than two. The number of the upper terminal assemblies 12 is plural. The total number of the upper terminals 121 of the plurality of upper terminal assemblies 12 is equal to the number of the upper terminal slots 102. The number of the upper terminals 121 of each of the upper terminal assemblies 12 is more than two.

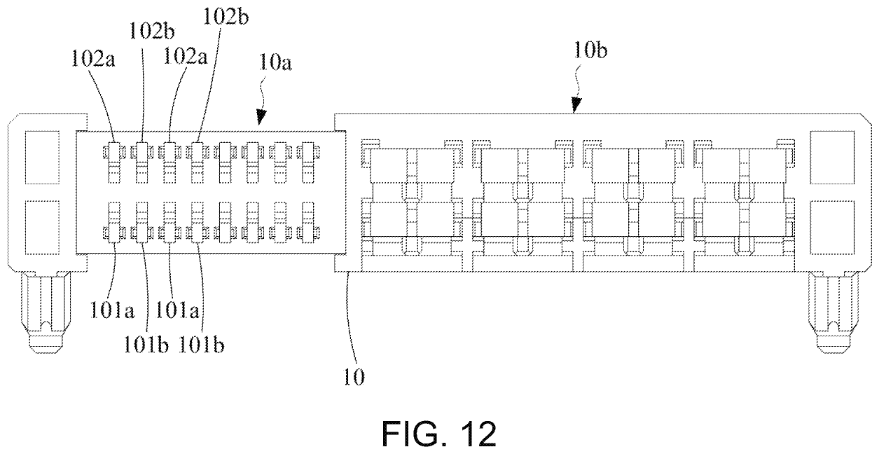

FIG. 12 is a rear view of a connector body of the third embodiment of the present disclosure. As shown in the figure, the configuration of the connector body 10 of this embodiment is similar to that of the first embodiment, and the difference lies in the assembling of the terminal of the signal area 10a of the connector body 10. In this embodiment, the signal area 10a also comprises a plurality of lower terminal slots and a plurality of upper terminal slots. There are two types of terminals disposed in the lower terminal slots, and there are also two types of terminals disposed in the upper terminal slots. In this way, the plurality of lower terminal slots provided with one type of terminal is referred to as the first lower terminal slot 101a, and the plurality of lower terminal slots provided with another type of terminal is referred to as the second lower terminal slot 101b. In the same way, the plurality of upper terminal slots provided with one type of terminal is called a first upper terminal slot 102a, and the plurality of upper terminal slots provided with another type of terminal is referred to as the second upper terminal slot 102b.

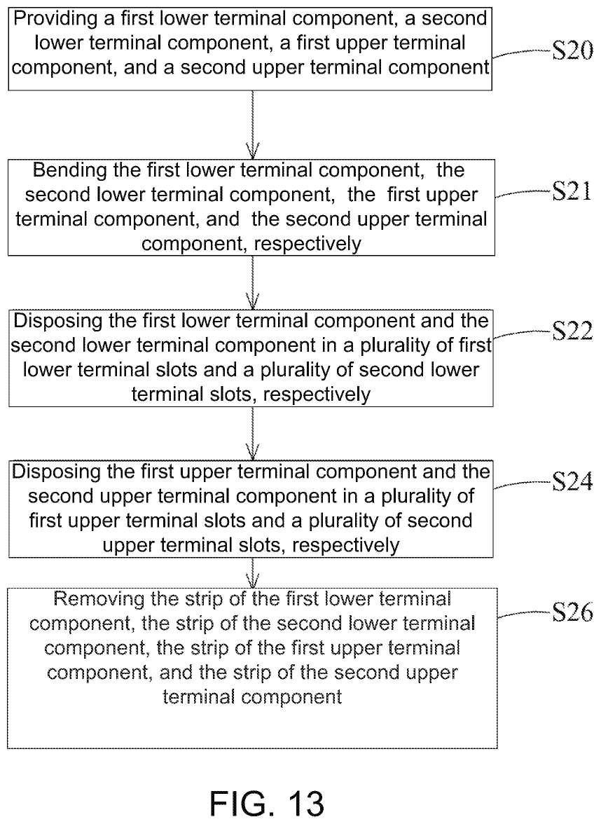

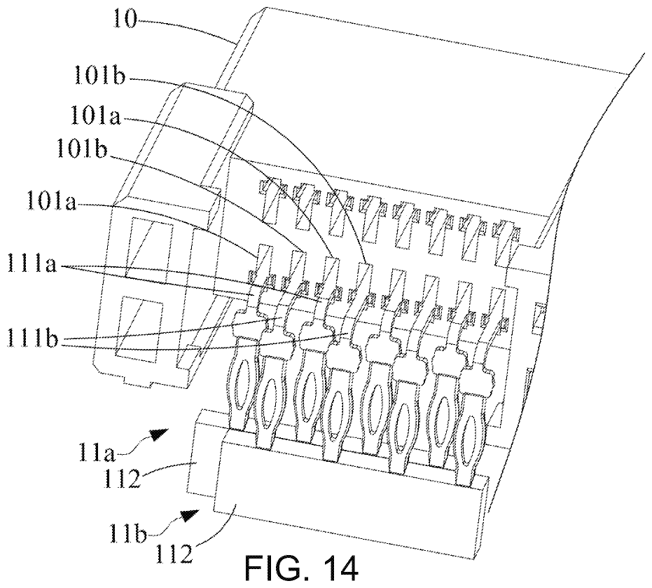

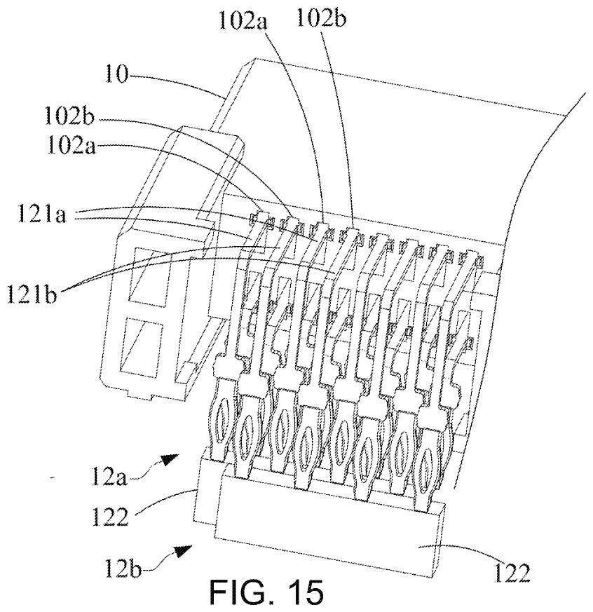

FIG. 13 is an assembling flowchart of a terminal of the third embodiment of the present disclosure. FIG. 14 and FIG. 15 are schematic diagrams of step S22 and step S24 of the third embodiment of the present disclosure.

As shown in the figure, the terminal assembling method of this embodiment is to first perform step S20 to provide a first lower terminal component 11a, a second lower terminal component 11b, a first upper terminal component 12a, and a second upper terminal component 12b. The first lower terminal component 11a comprises a plurality of first lower terminals 111a and a strip 112 connecting the plurality of connecting ends 1112 of the plurality of first lower terminals 111a. The second lower terminal component 11b comprises a plurality of second lower terminals 111b and a strip 112 connecting the plurality of connecting ends 1112 of the plurality of second lower terminals 111b. The first upper terminal component 12a comprises a plurality of first upper terminals 121a and a strip 122 connecting the plurality of connecting ends 1212 of the plurality of first upper terminals 121a. The second upper terminal component 12b comprises a plurality of second upper terminals 121b and a strip 122 connecting the plurality of connecting ends 1212 of the plurality of second upper terminals 121b. In this embodiment, the first lower terminal 111a, the second lower terminal 111b, the first upper terminal 121a, and the second upper terminal 121b are signal terminals.

Step S21 is then performed to bend the first lower terminal component 11a, the second lower terminal component 11b, the first upper terminal component 12a, and the second upper terminal component 12b, respectively. In this way, the plurality of first lower terminals 111a of the first lower terminal component 11a, the plurality of second lower terminals 111b of the second lower terminal component 11b, the plurality of first upper terminals 121a of the first upper terminal component 12a, and the plurality of second upper terminals 121b of the second upper terminal component 12b are bent-shaped.

Then, perform the step S22. The first lower terminal component 11a and the second lower terminal component 11b are respectively disposed in the plurality of first lower terminal slots 101a and the plurality of second lower terminal slots 101b. That is, the plurality of first lower terminals 111a of the first lower terminal component 11a are respectively inserted into the corresponding first lower terminal slots 101a, and the plurality of second lower terminals 111b of the second lower terminal component 11b are respectively inserted into the corresponding second lower terminal slots 101b. The strip 112 of the first lower terminal component 11a and the strip 112 of the second lower terminal component 11b are disposed at the outside of the connector body 10.

Then, perform the step S24. The first upper terminal component 12a and the second upper terminal component 12b are respectively disposed in the plurality of first upper terminal slots 102a and the plurality of second upper terminal slots 102b. That is, the plurality of first upper terminals 121a of the first upper terminal component 12a are respectively inserted into the corresponding first upper terminal slots 102a, and the plurality of second upper terminals 121b of the second upper terminal component 12b are respectively inserted into the corresponding second upper terminal slots 102b. The strip 122 of the first upper terminal component 12a and the strip 122 of the second upper terminal component 12b are disposed at the outside of the connector body 10.

The terminal assembling method of this embodiment is different from that of the first embodiment in that the removal of the strip 112 of the first lower terminal component 11a, the strip 112 of the second lower terminal component 11b, the strip 122 of the first upper terminal component 12a, and the strip 122 of the second upper terminal component 12b are suspended to the last step and then to be removed at simultaneously. This is because the plurality of first lower terminals 111a, the plurality of second lower terminals 111b, the plurality of first upper terminals 121a, and the plurality of first lower terminals 121b of this embodiment need to be covered by the cover 13. When the cover 13 is disposed on the plurality of first lower terminals 111a, the plurality of second lower terminals 111b, the plurality of first upper terminals 121a, and the plurality of second upper terminals 121b, the connector body 10 is disposed on the supporting fixtures. The plurality of first lower terminals 111a, the plurality of second lower terminals 111b, the plurality of first upper terminals 121a, and the plurality of second upper terminals 121b are fixed onto the supporting fixtures through the strip 112 of the first lower terminal component 11a, the strip 112 of the second lower terminal component 11b, the strip 122 of the first upper terminal component 12a, and the strip 122 of the second upper terminal component 12b, having the cover 13 to be mounted on the plurality of first lower terminals 111a, the plurality of second lower terminals 111b, the plurality of first upper terminals 121a, and the plurality of second upper terminals 121b.

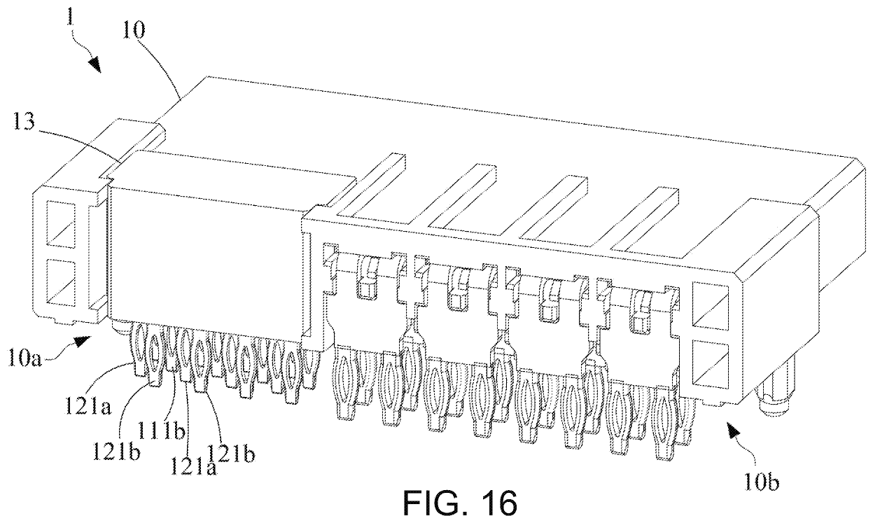

FIG. 16 is a perspective view of an electrical connector of the third embodiment of the present disclosure. As shown in the figure, after the installation of the cover 13 is completed, step S26 is then executed to remove the strip 112 of the first lower terminal component 11a, the strip 112 of the second lower terminal component 11b, the strip 122 of the first upper terminal component 12a, and the strip 122 of the second upper terminal component 12b. After completing the steps above, the terminal assembling of the signal area 10a is completed. In this embodiment, the number of the first lower terminal assemblies 11a is one, and the number of the first lower terminals 111a of the first lower terminal component 11a is the same as that of the first lower terminal slots 101a. The number of the second lower terminal assemblies 11b is one, and the number of the second lower terminals 111b of the second lower terminal component 11b is the same as that of the second lower terminal slots 101b. The number of the first upper terminal assemblies 12a is one, and the number of the first upper terminals 121a of the first upper terminal component 12a is the same as that of the first upper terminal slots 102a. The number of the second upper terminal assemblies 12b is one, and the number of the second upper terminals 121b of the second upper terminal component 12b is the same as that of the second upper terminal slots 102b. Since the first lower terminal component 11a, the second lower terminal component 11b, the first upper terminal component 12a, and the second upper terminal component 12b are bent in step S21 before being disposed in the first lower terminal slot 101a, the second lower terminal slot 101b, the first upper terminal slot 102a, and the second upper terminal slot 102b, there is no need for a positioning bottom cover to prevent the terminal from rebounding, which can reduce the overall size and weight of the electrical connector, and also reduce the difficulty of assembling.

In another embodiment, the number of the first lower terminal assemblies 11a is plural, and the number of the first lower terminals 111a of each of the first lower terminal assemblies 11a is more than two. The total number of first lower terminals 111a of the plurality of first lower terminal assemblies 11a is the same as the number of first lower terminal slots 101a. The number of the second lower terminal assemblies 11b is plural, and the number of the second lower terminals 111b of each of the second lower terminal assemblies 11b is more than two. The total number of the second lower terminals 111b of the plurality of second lower terminal assemblies 11b is the same as the number of the second lower terminal slots 101b. The number of the first upper terminal assemblies 12a is plural, and the number of the first upper terminals 121a of each of the first upper terminal assemblies 12a is more than two. The total number of the first upper terminals 121a of the plurality of first upper terminal assemblies 12a is the same as the number of the first upper terminal slots 102a. The number of second upper terminal assemblies 12b is plural, and the number of second upper terminals 121b of each of the second upper terminal assemblies 12b is more than two. The total number of the second upper terminals 121b of the plurality of second upper terminal assemblies 12b is the same as the number of the second upper terminal slots 102b.

In one embodiment, the plurality of first lower terminal slots 101a and the plurality of second lower terminal slots 101b are staggered disposed. When the first lower terminal component 11a and the second lower terminal component 11b are respectively disposed in the plurality of first lower terminal slots 101a and the plurality of second lower terminal slots 101b, the plurality of first lower terminals 111a and the plurality of second lower terminals 111b are staggered disposed, and the strip 112 of the second lower terminal component 11b is disposed at the outside of the strip 112 of the first lower terminal component 11a. Similarly, the plurality of first upper terminal slots 102a and the plurality of second upper terminal slots 102b are staggered disposed. When the first upper terminal component 12a and the second upper terminal component 12b are respectively disposed in the plurality of first upper terminal slots 102a and the plurality of second upper terminal slots 102b, the plurality of first upper terminals 121a and the plurality of second upper terminals 121b are staggered disposed, and the strip 122 of the second upper terminal component 12b is disposed at the outside of the strip 122 of the first upper terminal component 12a.

In this embodiment, the lengths of the first lower terminal 111a, the second lower terminal 111b, the first upper terminal 121a, and the second upper terminal 121b protruding from the connector body 10 are different, having the first lower terminal 111a, the second lower terminal 111b, the first upper terminal 121a, and the second upper terminal 121b are spaced apart from each other.

In summary, the present disclosure proposed a method for assembling a terminal of an electrical connector. When a terminal component is disposed in the plurality of terminal slots, the plurality of terminals of the terminal component could be disposed in the plurality of terminal slots all at once by integrating a plurality of terminals into an integrated terminal component by a strip. In addition, the plurality of terminals disposed in the plurality of terminal slots are bent shaped, which are bent through a bending fixture before the terminal component is disposed in the plurality of terminal slots. Thus, the bending degree of the plurality of terminals would be consistent, so as to facilitate following processings.

It is to be understood that the term “comprises”, “comprising”, or any other variants thereof, is intended to encompass a non-exclusive inclusion, such that a process, method, article, or device of a series of elements not only include those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A method for assembling a terminal of an electrical connector, the electrical connector comprising a connector body, a plurality of lower terminal slots and a plurality of upper terminal slots corresponding to the plurality of lower terminal slots, the method comprising:
providing a lower terminal component and an upper terminal component, the lower terminal component comprising a plurality of lower terminals and a strip connecting with the plurality of lower terminals, the upper terminal component comprising a plurality of upper terminals and a strip connecting with the plurality of upper terminals;
disposing the lower terminal component in the plurality of lower terminal slots, the plurality of lower terminals being respectively disposed in the corresponding lower terminal slots; and
disposing the upper terminal component in the plurality of upper terminal slots, the plurality of upper terminals being respectively disposed in the corresponding upper terminal slots.

2. The method according to claim 1, wherein before the step of disposing the lower terminal component in the plurality of lower terminal slots, the lower terminal component and the upper terminal component are bent to allow the plurality of lower terminals and the plurality of upper terminals to be bent-shaped.

3. The method according to claim 1, wherein after the step of disposing the lower terminal component in the plurality of lower terminal slots, the strip of the lower terminal component is removed.

4. The method according to claim 3, wherein after the step of disposing the upper terminal component in the plurality of upper terminal slots, the strip of the upper terminal component is removed.

5. The method according to claim 1, wherein after the step of disposing the upper terminal component in the plurality of upper terminal slots, the strip of the lower terminal component and the strip of the upper terminal component are removed.

6. The method according to claim 1, wherein the number of the lower terminal assemblies is one; the number of the lower terminals of the lower terminal component is more than two and is equal to the number of the lower terminal slots.

7. The method according to claim 1, wherein the number of the upper terminal assemblies is one; the number of the upper terminals of the upper terminal component is more than two and is equal to the number of the upper terminal slots.

8. The method according to claim 1, wherein the number of the lower terminal assemblies is plural; the number of the lower terminals of the lower terminal component is more than two; the total number of the lower terminals of the plurality of the lower terminal components is equal to the number of the lower terminal slots.

9. The method according to claim 8, wherein the number of the upper terminal assemblies is plural; the number of the upper terminals of the upper terminal component is more than two; the total number of the upper terminals of the plurality of the upper terminal components is equal to the number of the upper terminal slots.

10. The method according to claim 9, wherein the plurality of lower terminal slots comprise a plurality of first lower terminal slots and a plurality of second lower terminal slots; the plurality of lower terminal components comprise a first lower terminal component and a second lower terminal component; the step of disposing the lower terminal component in the plurality of lower terminal slots comprises the disposing of the first lower terminal component in the plurality of first lower terminal slots and the disposing of the second lower terminal component in the plurality of second lower terminal slots.

11. The method according to claim 10, wherein the plurality of upper terminal slots comprise a plurality of first upper terminal slots and a plurality of second upper terminal slots; the plurality of upper terminal components comprise a first upper terminal component and a second upper terminal component; the step of disposing the upper terminal component in the plurality of upper terminal slots comprises the disposing of the first upper terminal component in the plurality of first upper terminal slots and the disposing of the second upper terminal component in the plurality of second lower terminal slots.

12. The method according to claim 11, wherein the lengths of the lower terminal of the first lower terminal component, the lower terminal of the second lower terminal component, the upper terminal of the first upper terminal component and the upper terminal of the second upper terminal component protruding from the connector body are different.
